(19) United States
(12) Patent Application Publication
(10) Pub. No.: US 2020/0042898 A1
(43) Pub. Date: Feb. 6, 2020

(54) PREFERENCE DATA REPRESENTATION AND EXCHANGE

(71) Applicant: Vulcan Inc., Seattle, WA (US)

(72) Inventors: Richard Ignacio Zaragoza, Issaquah, WA (US); Richard Earl Simpkinson, Issaquah, WA (US); Keith Rosema, Seattle, WA (US); Rusty A. Gerard, Bothell, WA (US); Shamyl Emrich Zakariya, Seattle, WA (US); Jeffrey Alex Kramer, Redmond, WA (US); Paul G. Allen, Mercer Island, WA (US)

(21) Appl. No.: 16/529,401

(22) Filed: Aug. 1, 2019

Related U.S. Application Data
(60) Provisional application No. 62/714,522, filed on Aug. 3, 2018.

(51) Int. Cl. G06N 20/00; G06N 5/04

(52) U.S. Cl. CPC G06N 20/00; G06N 3/08; G06N 5/04

(57) ABSTRACT

A system obtains preference information by observing interaction, on behalf of a user, with a first service. A machine learning model is trained, based on the preference information. The system stores configuration data for the machine learning model. When a second service is invoked, the system provides the configuration data based at least in part on determining that the first and second services share a common classification. The second service reconstitutes the machine learning model and adjusts the interaction based at least in part on predictions made using the reconstituted machine learning model.

### CROSS-REFERENCE TO RELATED APPLICATIONS

This application claims the benefit of U.S. Provisional Patent Application No. 62/714,522, filed Aug. 3, 2018, the disclosure of which is herein incorporated by reference in its entirety.

### BACKGROUND

It has become increasingly common for business entities to acquire and leverage vast amounts of data in order to predict consumer behavior. Sharing data about consumer behavior can provide a number of advantages to the consumer. However, the data is often stored in an inefficient or insecure manner. It therefore remains challenging to provide useful predictive data in a manner that preserves privacy and security.

### BRIEF DESCRIPTION OF THE DRAWINGS

Various techniques will be described with reference to the drawings, in which:

FIG. 1 illustrates an example of a preference data exchange system, in accordance with at least one embodiment;

FIG. 2 illustrates an example of access controls in a preference data exchange system, in accordance with at least one embodiment;

FIG. 3 illustrates an example of contextual application of an access control policy, in accordance with at least one embodiment;

FIG. 4 illustrates an example of a taxonomy, in accordance with at least one embodiment;

FIG. 5 illustrates an example of a system employing a preference exchange data format comprising machine learning model data, in accordance with at least one embodiment;

FIG. 6 illustrates an example of further aspects of a system employing a preference exchange data format comprising machine learning model data, in accordance with at least one embodiment;

FIG. 7 is a flowchart illustrating an example of a process for exchanging preference data as configuration data for a machine learning model, in accordance with at least one embodiment; and

FIG. 8 illustrates an environment in which various embodiments can be implemented.

### DETAILED DESCRIPTION

Described herein are systems and techniques for providing user preference information. In one example, a browser application tracks certain user interactions with a service, and uses information about those interactions to generate a machine learning model. The parameters of the machine learning model are provided in the context of further interactions with the service. These online services reconstruct the machine learning model based on the shared parameters, and use the model to make predictions or gain other insights into the user's behavior.

Preference information refers to data, associated with a user or entity, which is indicative of a pattern, like, interest, aversion, or association. Such information may be obtained by observation of interactions that are performed, with a service, on behalf of the user or entity. For example, a browser or other application may interact with an online store or other website in a manner that is suggestive of the various types of preference information just described. However, explicit exchange of information may be problematic in a number of respects, such as with respect to privacy and security, and may also be difficult to leverage. In at least some of the embodiments disclosed herein, such information is used to train a machine learning model, but not exchanged directly with a service that uses the machine learning model.

A machine learning model refers to models associated with any of a variety of machine learning techniques. Examples include, but are not limited to, artificial neural networks, Bayesian classifiers, decision trees, regressions, and so forth. It will be appreciated that these examples are provided for illustrative purposes, and as such the provided examples should not be construed in a manner which would limit the scope of the present disclosure to include only those embodiments which employ the specific examples provided. Various examples provided herein may refer to neural networks as an example of a machine learning model. However, the use of neural networks for illustrative purposes should also not be viewed as limiting the scope of the present disclosure to only those embodiments which employ artificial neural networks. A variety of machine learning models may be employed.

Configuration data for a machine learning model may include information, such as the weights, bias terms, and thresholds of an artificial neural network, which represents the model's training or knowledge. Together with the structure of the model, this data encodes the information needed to make a prediction. One advantage of this approach is that the data used to train the model need not be retained or shared in order to provide a service with a predictive capability.

Also described herein are techniques and systems related to control over access to preference data, such as the configuration data for a machine learning model trained according to a user's preferences. As described herein, preference information may be classified according to a taxonomy. Access controls may be associated with regions of the taxonomy, so that different regions may be subject to different levels of access control. Moreover, access controls may be applied in view of contextual data, such as the relative locations of the source and recipient of the preference data.

Also described herein are techniques and system related to identifying a machine learning model that corresponds to a classification of an interaction with a service. In an example, a system responses to the initiation of a transaction with a service by classifying the transaction according to a taxonomy. The system then identifies a machine learning model based on the classification. The identified model may then be trained to make a prediction relevant to the interaction, or if already trained, provided to the service in order to make a prediction.

In the preceding and following description, various techniques are described. For purposes of explanation, specific configurations and details are set forth in order to provide a thorough understanding of possible ways of implementing the techniques. However, it will also be apparent that the techniques described below may be practiced in different configurations without the specific details. Furthermore, well-known features may be omitted or simplified to avoid obscuring the techniques being described.

Techniques described and suggested in the present disclosure improve the field of computing, especially those fields which may utilize predictions of user behavior. Techniques described herein also provide information providers and information consumers with control over the sharing of preference information. Moreover, techniques described herein improve the efficiency of computing systems which make decisions based on preference data, and also addresses privacy concerns related to the storage of preference data.

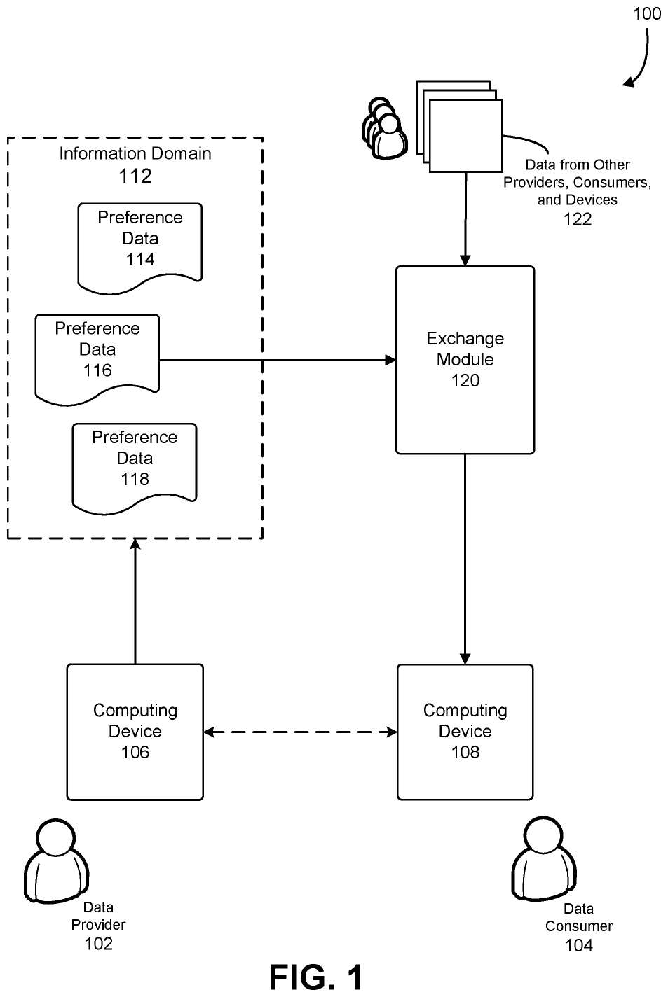

FIG. 1 illustrates an example of a preference data exchange system, in accordance with at least one embodiment. The example data exchange system 100 provides exchange of user preference information between a data provider 102 and data consumer 104.

The example system 100 includes an exchange module 120. A module, as used herein, refers to a memory and processor-executable instructions, at least some of which are loaded into the memory. The processor-executable instructions, in response to being executed by at least one processor, cause a computing system comprising the memory and the at least one processor to perform the described functions of the module. In the example embodiment of system 100, the exchange module 120 may operate on a computing device, which may for example be a computing device that is part of a hosted computing service which acts as an intermediary between the respective computing devices 106 and 108 of the data provider 102 and data consumer 104. The computing devices 106 and 108 may be any of a variety of devices, such as personal computers, smartphones, tablets, augmented reality devices, and so on.

The data provider 102 may generate various forms of information based on interactions performed, on its behalf, between the computing devices 106 and 108. The information may include preference data 114-118, which can represent the data provider's preferences regarding various things, such as preferred brands, preferred vendors, preferred products, preferred environmental conditions, and so on.

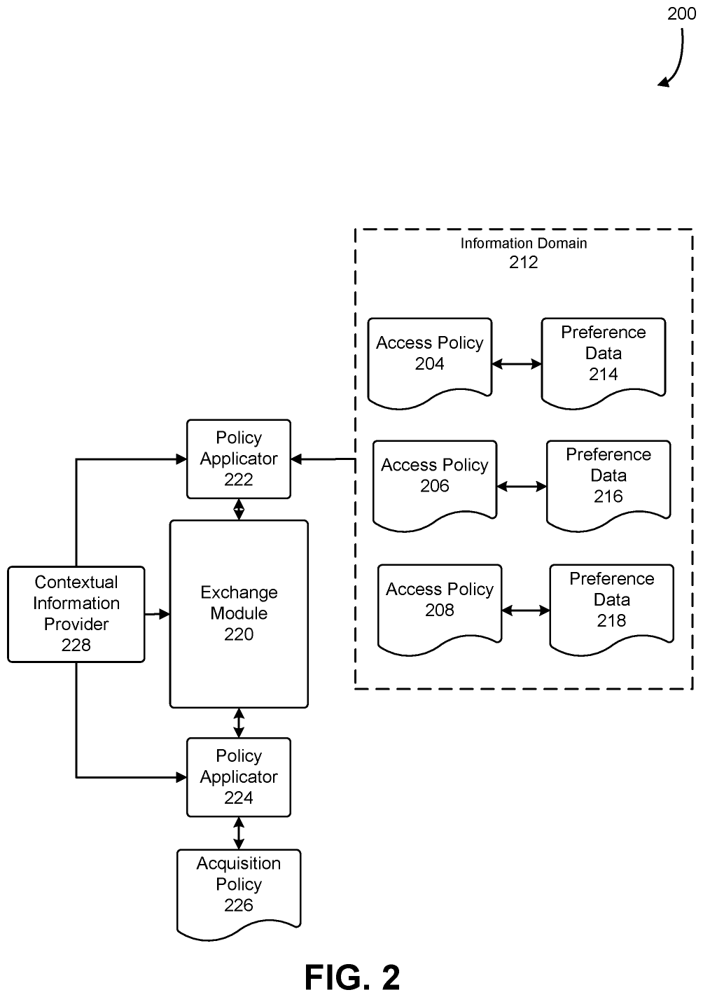

The preference data 114-118, and other data, may be associated with an information domain 112. In at least one embodiment, the information domain 112 comprises data associated with, generated by, or concerning the data provider 102. For example, in an embodiment, the data provider 102 is a person, and the information domain 112 includes preference information regarding that person. This may include preference data, as well as other data such as the person's phone number, zip code, and so on. In many cases, this information is privacy-sensitive and therefore subject to various forms of access control, in order to protect the person's privacy. For example, the system 100 may apply various access control policies to control access to data in the information domain 112. The access control policies may be granular, such that access to provider data 114 is governed according to one policy, access to provider data 116 is governed according to a second policy, and provider data 118 governed according to a third policy. FIG. 2 depicts further aspects of access control as applied by the system 100.

The data consumer 104 may be an entity, such as a person or business, associated with a computing device. More generally, the data consumer 104 is an entity to whom information in the information domain 112 may be made at least partially available. The data consumer 104 is associated, in at least one embodiment, with the computing device 108.

In various cases and embodiments, proximity of the computing device 106 to the computing device 108 triggers one or more interactions between the computing devices 106 and 108 and the exchange module 120. The interactions, in these cases and embodiments, pertain to the exchange of information usable by the data consumer 104 and willing to be provided by the data provider 102.

The value of the information to the data consumer 104, and the willingness of the data provider 102, may vary according to a number of contextual factors. There may be some information which the data provider 102 is never willing to share, or is only willing to share in a specific context. This information may be provided by either or both of the devices 106, 108, or by come from data 122 provided by other providers, consumers, or devices.

In various cases and embodiments, the exchange module 120 facilitates, between the computing devices 106 and 108 of the data provider 102 and data consumer 104, an exchange of information in the information domain 112. Information may be exchanged using the exchange module 120 as an intermediary. However, in at least one embodiment, the computing devices 106 and 108 exchange at least some information directly.

FIG. 2 illustrates an example of access controls in a preference data exchange system, in accordance with an embodiment. In the example 200, an exchange module 220 facilitates an exchange of information in an information domain 212. The information domain 212, preference data 214-218, and exchange module 220 in FIG. 2 may correspond to the information domain 112, preference data 114-118, and exchange module 110 depicted in FIG. 1. Likewise, the depicted example 200 may involve an exchange of information between a data provider and data consumer, based on interaction between the data provider's and data consumer's respective computing devices 106 and 108.

Information in the information domain 212 may be associated with various access control policies. For example, preference data 214 may be associated with an access policy 204, preference data 216 may be associated with an access policy 206, and preference data 218 may be associated with an access policy 208.

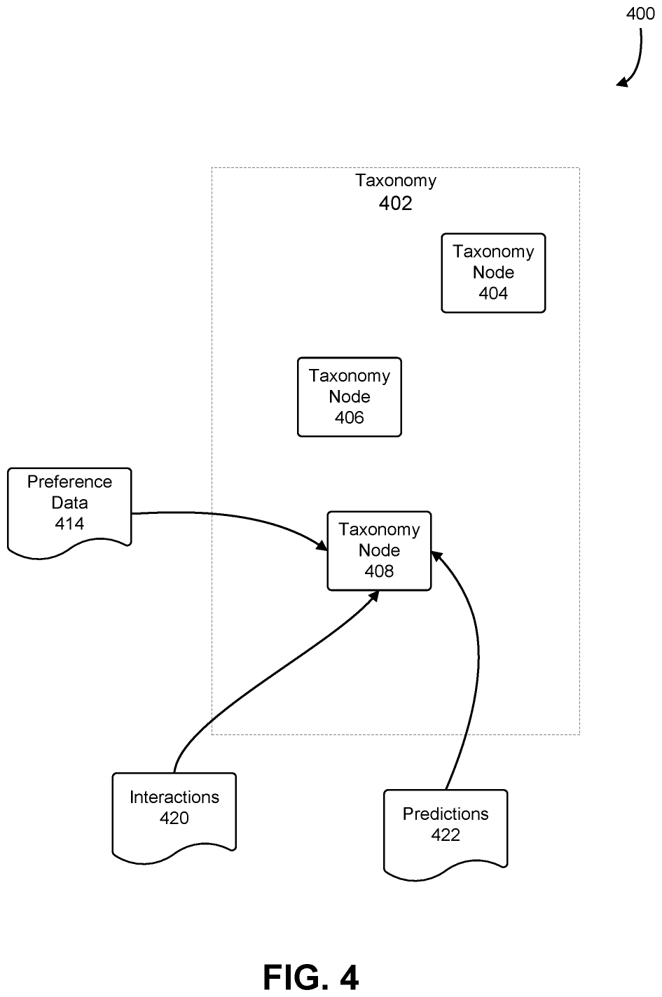

Embodiments may associate policies with data according to classification of the data. For example, in FIG. 2 the preference data 214 might be classified as commonly shared data, the preference data 216 might be classified as sometimes-shared data, and the preference data 218 might be rarely shared data regarding more sensitive subjects. The corresponding access policies 204-208 might then be generated to define policies appropriate to each type of preference information. FIG. 4 illustrates an example of classification. As illustrated by FIG. 4, information in the information domain 212, such as preference information, may be classified according to a taxonomy, and information associated with elements of the taxonomy associated with a corresponding access policy.

Returning to FIG. 2, a policy applicator 222 provides access to the preference data 214-218 according to corresponding access policies 204-208. In at least one embodiment, the policy applicator 222 is a module whose execution is hosted on a computing device operated by a cloud computing provider. In at least one other embodiment, the policy applicator 222 is a module that executes on a computing device more directly associated with the information provider, such as with the provider's augmented reality device, smartphone, tablet, and so on. In at least one embodiment, the policy applicator 222 is combined with the exchange module 220. In at least one embodiment, the policy applicator 222 is distributed among several modules, such as a module hosted by a cloud computing facility and a module executing on a computing device of the information provider. Each instance of the policy applicator 222 may manage access to a portion of the data that comprises the information domain 212. The data in the information domain may be stored in various locations, such as in cloud storage and/or on a computing device of the information provider.

In at least one embodiment, an additional policy applicator 224 represents the data acquisition policy 226 of a data consumer. For example, a data consumer may wish to initiate the acquisition of certain types of preference data, or to block the acquisition of other types. It may be the case, for example, that a data consumer might wish to acquire only those machine learning models trained to make a particular type of prediction.

In at least one embodiment, the policy applicators 222 and 224 facilitate an exchange of preference data between an information provider and an information consumer. In at least one embodiment, the data provider's policy applicator 222 proceeds by first determining whether any particular categories of preference information are being requested by a provider. The request categories may include, for example, those for which machine learning models might be available.

The policy applicator 222 then locates the requested information within the information domain 212. For example, the information in the information domain 212 may be represented by a taxonomy which categorizes preference information. The taxonomy may also provide mappings between elements of the taxonomy and access policies. Certain categories of information, as represented by certain elements of the taxonomy, may be hidden from inspection. The policy applicator 222 may then make an initial determination as to whether there is a potential for providing the preference information, and then determine whether all conditions for such provision are satisfied. If so, the information may be provided to the information consumer via the exchange module 220. In certain cases, the information consumer's policies, as reflected by the actions of its corresponding policy applicator 224, will participate in this process by indicate which categories of information are requested, or which might be made use of, and which categories of information would not be accepted. For example, a certain machine learning model might be shared based on the types of predictions the model is capable of making, and a policy of the information provider or information consumer for providing or consuming such information.

As discussed in conjunction with FIG. 2, the exchange of information between an information provider and information consumer may be initiated and applied in accordance with various contextual information. The contextual information provider 228 may provide data used by the respective policy applicators 222 and 224 in determining whether access to preference information should be granted. For example, a policy might indicate that machine learning models associated with certain regions of the taxonomy are accessible only when the participants are at a certain location, at a certain time of day, for executing certain types of transactions, and so forth.

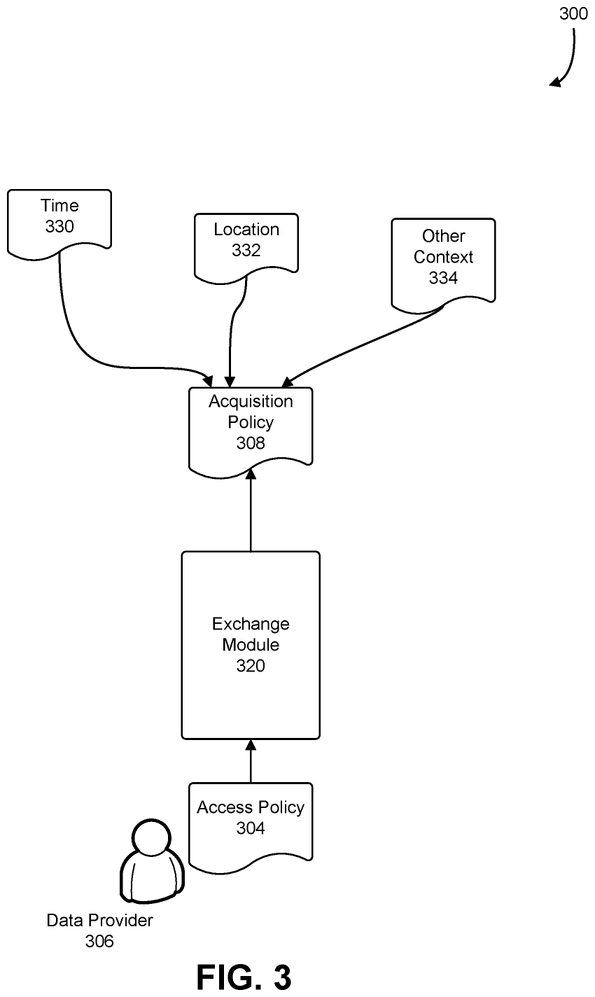

FIG. 3 illustrates further aspects of contextual application of an access control policy, in accordance with at least one embodiment. In the example 300, an exchange module 320 facilitates an acquisition of information from a data provider. The exchange module may correspond to the exchange modules depicted in FIGS. 1 and 2.

In the example 300, the data provider 306 possesses or generates various forms of preference information. The provision of this preference information is governed by an access policy 304. Similar, the acquisition of the preference information are governed by an acquisition policy 308. The system provides preference information when indicated by both the access policy and acquisition policy.

In at least one embodiment, the access policy 304 and acquisition policy 308 are initiated and applied in accordance with contextual information. The contextual information may include, for example, time 330, location 332, and other context information 334.

Time 330 refers to information about the time of a prospective exchange of information. There may be a variety of situations in which the value of a transaction is influenced by time. As such, time 330 information may be correlated to other information, such as location 332 or other contextual information 334.

Location 332 refers to information about the locations of the respective parties. In an embodiment, a negotiation for the acquisition of information is triggered in response to the arrival of the information provider at a store or other location associated with the information consumer.

A variety of other contextual information 334 may also be considered by the access policy 304 or acquisition policy 308. For example, there may be other information about the information provider, perhaps obtained through a prior exchange of information or from sources outside of the information provider's information domain.

FIG. 4 illustrates an example of a taxonomy, in accordance with at least one embodiment. In the example 400, a taxonomy 402 comprises nodes 404-408. A taxonomy, as used herein, refers to a scheme of classification for data. The taxonomy may be structured in a variety of ways, such as by subdivision into sets, directed graphs, and so forth. The taxonomy nodes 404-408 represent subdivisions or regions of the taxonomy, such that each of the nodes 404-408 represents data sharing a common classification.

In at least one embodiment, a taxonomy node 408 comprises, or refers to, preference data 414, interactions 420, and predictions 422. The preference data 414 may comprise parameters or other configuration data for one or more machine learning models. The interactions 420 may comprise indications of functions, services, or transactions which relate to the classification associated with the taxonomy node 408. The predictions 422 may indicate various questions which might be relevant to the related interactions. For example, for interactions related to ordering food from a restaurant, the predictions might pertain to models for predicting food-related preferences, such as favorite foods, flavors, spiciness levels, and so on.

In an embodiment, the taxonomy 402 classifies data according to semantic meaning. For example, information related to food choice might be grouped in one region of the taxonomy, while information related to travel preferences might be grouped in another region. Each region might contain one or more nodes of the taxonomy. Similarly, the taxonomy 402 may classify data according to the types of questions associated with each region of the taxonomy. For example, the taxonomy might include one region corresponding to a specific prediction regarding food choice, and another region corresponding to a specific prediction regarding automobile preferences. These regions may also be associated with specific interaction types, such as food-related interactions in the first case, and automobile-related interactions in the second.

In an embodiment, the taxonomy 402 classifies data according to sensitivity. For example, information typically viewed as very sensitive might be classified as “highly sensitive,” less sensitive information might be classified as “sensitive,” and innocuous information might be classified as “least sensitive.”

In other embodiments, a combination of classifications might be employed. For example, data might be arranged in hierarchical fashion, first by semantic meaning and then by sensitivity. Alternatively, the hierarchy might first comprise sensitivity and then semantic meaning.

In cases and embodiments, the taxonomy 402 is a pre-defined taxonomy used by each participant in the exchange of information, i.e., by the computing devices of the data provider and the data consumer, by the exchange module, and by the various policy applicators.

In other cases and embodiments, a plurality of such taxonomies is employed. For example, in at least one embodiment, the information provided by the information provider is classified by a first taxonomy, and the information consumed by the information consumer is classified by a second taxonomy. The access policies of the information provider use the first taxonomy, and the acquisition policies of the information consumer use the second taxonomy. Translation between the two taxonomies occurs as needed.

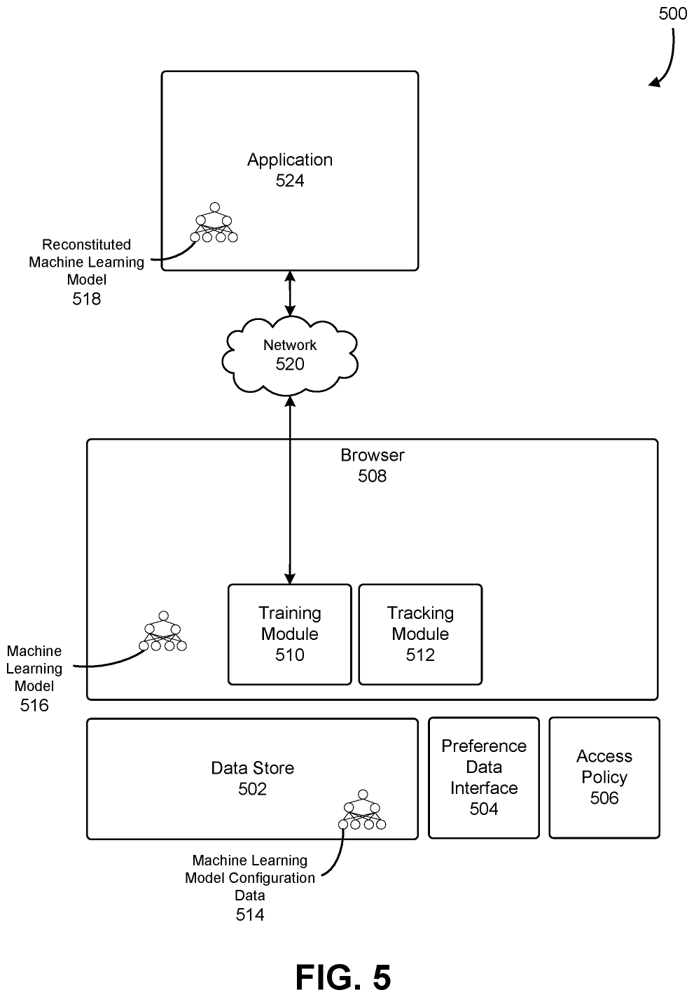

FIG. 5 illustrates an example of a system employing a preference exchange data format comprising machine learning model data, in accordance with at least one embodiment. In the example system 500, a browser 508 uses a tracking module 512 to obtain preference information and a training module 510 to generate and store preference information in a data store 502.

In at least one embodiment, the browser 508 corresponds to a web browser, or to some other application which incorporates web browsing features. The example of a browser is intended to be illustrative, rather than limiting. As such, in other embodiments, application types other than browsers may use the techniques disclosed herein to generate, store, and utilize preference information.

In at least one embodiment, interactions performed via the browser, or other application, are monitored to generate preference information. For example, a browser application might, on behalf of a user, perform various online shopping tasks, retrieve various news articles, send messages to other accounts via a social media platform, and so forth. Each of these actions may be described as an interaction performed on behalf of the user. From these interactions, a predictive learning model may be generated to represent the user's preferences with regard to certain questions or patterns associated with the interactions. For example, interactions related to food purchases might be used to generate weights for a machine learning model for the question “what food does this person prefer?”

In at least one embodiment, the tracking module 512 observes the user's interactions and provides preference information, based on the interactions, to a training module 510. The information is used by the training module 510 to train a machine learning model 516 to answer questions or make predictions pertaining to the user of the browser.

In at least one embodiment, the tracking module 512 categorizes an observed interaction using a taxonomy. A mapping is then obtained, from the corresponding region or node of the taxonomy, to one or more questions that may be answered by observing the result of the interaction. The questions are mapped to one or more machine learning models that, when trained, may be used to predict answers to the corresponding questions, as applied to future interactions that map to the same question or questions. The training is done using the observed results of the present interaction.

In an embodiment, the browser 508 stores configuration data 514 for the machine learning model in a data store 502. In at least one embodiment, the data is stored in or as a browser cookie. The configuration data 514 can include parameters for the machine learning model, such as the weights of a neural network. When the machine learning model 516 is trained, the configuration data 514 represents the knowledge gained from this training, and may be used to reconstitute the machine learning model so that the model can make predictions based on this knowledge.

In an embodiment, a preference data interface 504 provides definition of a machine learning model 516 whose weights are or may be stored in the data store 502. The preference data interface 504 may also provide information describing the questions that may be posed to the machine learning model 516, and information about how those questions may be posed. Thus, if both the machine learning model configuration data 514 and the definitions from the preference data interface 504 are possessed by a device, that device may reconstitute the machine learning model 518, as a corresponding machine learning model 518, and use it to make the predictions for which it was changed. In at least one embodiment, access to the machine learning model configuration data 514 and/or the definitions from the preference data interface 504 is governed by an access policy 506, or similarly by an acquisition policy. The policies may function similarly to the access control policies described herein, e.g. with respect to FIGS. 1 and 2.

In an embodiment, the use of a preference exchange interface 504 is omitted. Alternatives to using the interface 504 include standardizing the machine learning model inputs and outputs, such that the model may be used by any device that is aware of the standardization and is in possession of the machine learning model configuration data 514.

In at least one embodiment, the configuration data 514 is encrypted. Access to the decryption key may be governed by the access policy 506.

The machine learning model configuration data in the data store 502 may be managed, in various aspects, by the browser 508. For example, in at least one embodiment, the configuration data 514 may be provided to other systems when a browsing session is initiated, when a web page is visited, a web form submitted, and so forth. In various cases and embodiments, the machine learning model configuration data 514 is managed in a manner similar to a cookie. For example, the configuration data 514 may be included in various requests and other communications with a web server associated with a particular domain or web site. For example, machine learning model configuration data 514 might be associated with a specific web domain and in hypertext transfer protocol (“HTTP”) messages sent to that domain. Accordingly, the machine learning model may be trained based on interactions occurring with that domain, and the configuration data for the machine learning model shared in subsequent interactions with the same domain.

An application 524 running on another device may obtain predictions using a reconstituted machine learning model 518, corresponding to the machine learning model 516 trained by the browser 508. The machine learning model 518 is reconstituted based on the machine learning model configuration data 514 sent to the application 524 by the browser 508, via the network 520. Here, reconstituting the machine learning model comprises restoring the previously stored configuration data 514, so that the weights, thresholds, bias terms, and so forth are the same in the reconstituted machine learning model 518 as they were in the original model 516. The application 524 may, for example, receive the configuration data 514, reconstitute the machine learning model 516, and then use the reconstituted machine learning model 518 to make predictions.

In at least one embodiment, the application 524 provides information to the browser 508 to indicate which predictions it would like to make. The browser 508, based on the taxonomy, identifies machine learning models that have been trained and whose configuration is available in the data store 502. The browser 508 then provides the relevant configuration data to the application 524, subject to applicable access control policies.

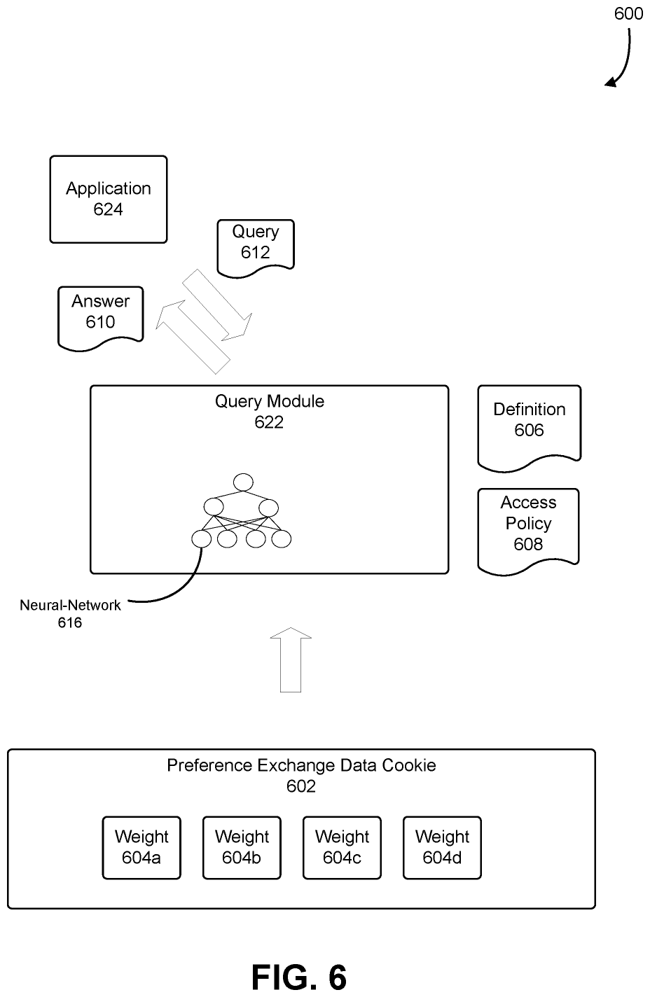

FIG. 6 illustrates an example of further aspects of a system employing a preference exchange data format comprising machine learning model data, in accordance with at least one embodiment. In the example 600, an application 624 interacts with a query module 622 to receive an answer 610 to a query 612. The answer 610 is provided by using a neural network 616 based on weights 604a-d provided in a preference exchange data cookie 602. A definition 606 defines inputs and outputs of the neural network. An access control policy 608 defines circumstances in which access to the weights 604a-d would be provided. In at least one embodiment, the access control policy 608 also governs access to the definition 606 of the neural network, and may also govern access to any encryption keys necessary to access the information.

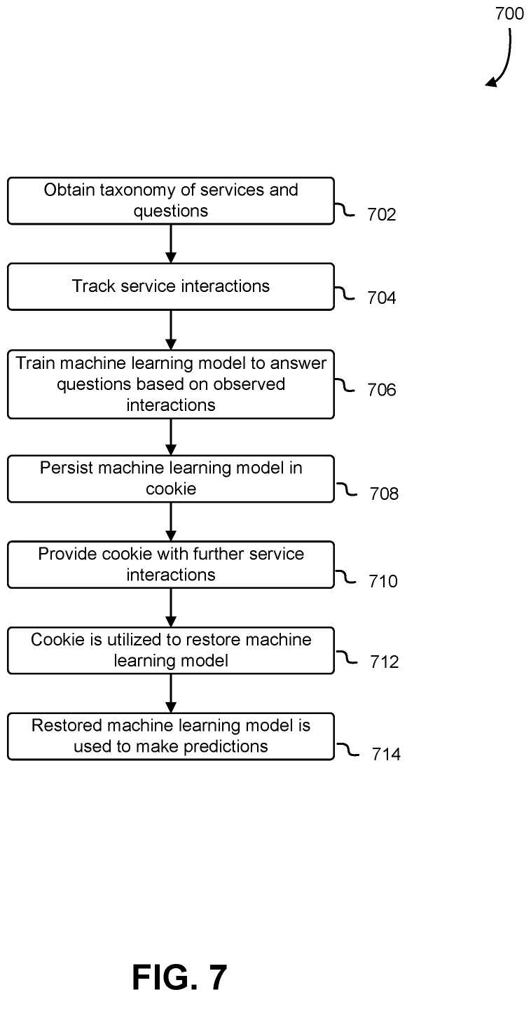

FIG. 7 is a flowchart illustrating an example of a process 700 for exchanging preference data as configuration data for a machine learning model, in accordance with at least one embodiment. Some or all of the process 700 (or any other processes described, or variations and/or combinations of those processes) may be performed under the control of one or more computer systems configured with executable instructions and/or other data, and may be implemented as executable instructions executing collectively on one or more processors. The executable instructions and/or other data may be stored on a non-transitory computer-readable storage medium (e.g., a computer program persistently stored on magnetic, optical, or flash media). Note that unless logically required, the depicted operations may be performed in various orders and combinations, including in parallel.

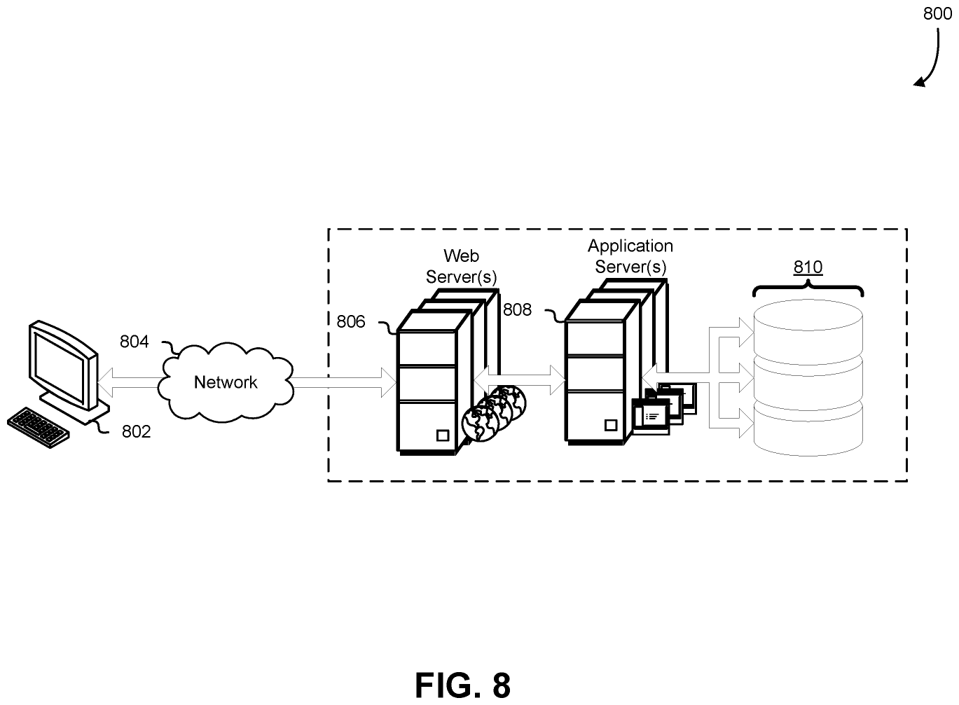

Some or all of process 700 may be performed by a suitable system, such as a computing device on which a browser application operates. Some parts of the process may be performed by a server in a data center, by various components of the environment 800 described in conjunction with FIG. 8, such as the one or more web servers 806 or the one or more application servers 808, by multiple computing devices in a distributed system of a computing resource service provider, or by any electronic client device such as the electronic client device 802.

The process 700 includes a series of operations wherein preference data is provided, indirectly, as a machine learning model. Here, indirectness may refer to the obfuscation of the preference data by its encoding within the machine learning model. For example, a user's preference data may be transformed, by a browser during a training process, into a latent space encoding. Here, the latent space encoding refers to the learned ability of the machine learning model to project aspects of the user's preference data into a multi-dimensional space used by the model for classification, regression, and so forth. Such spaces are referred to as latent at least partly because the encoding is hidden from direct inspection. Thus, the machine learning model may be used to make predictions, but the original preference data is not obtainable from it. It will be appreciated that this example is intended to be illustrative, and as such should not be construed in a manner which would limit the scope of the present disclosure to only those embodiments which include the example provided.

In the example embodiment of FIG. 7, a neural network is used, although numerous other machine learning models might also be employed. Examples include, but are not limited to, genetic algorithms, probabilistic techniques, highly non-linear functions, and so forth.

At 702, a browser application, or other application, obtains a taxonomy, such as the example taxonomy described in relation to FIG. 4. Among other functions, the taxonomy may provide contextual and semantic meaning to potential interactions with various services. The operations may include those such as browsing a web page, adding an item to an electronic shopping cart, interacting with a social media application, and so on. The taxonomy may also be used to map these interactions to questions or predictions, to find a machine learning model that might be trained based on the interaction, or to find an already-trained machine learning model that might be provided to the service in the course of performing the interaction.

At 704, the browser or other application tracks interactions with the various services. In at least one embodiment, the tracking is based on the taxonomy. When an interaction with a service is observed, the system uses the taxonomy to determine what, if any, machine learning models might be trained based on an observation about the interaction. For example, if the user is employing a browser to purchase a toy from an online toy store, the taxonomy might indicate that a machine learning model, for predicting shopping preferences, is available for training. It will be appreciated that this example is intended to be illustrative, rather than limiting, and as such should not be construed in a manner which would limit the scope of the present disclosure to only those embodiments which employ the specific example provided.

At 706, the system trains the neural network. For example, if a user employs a browser to purchase a toy from an online toy store, the browser might then proceed to train the neural network to answer questions such as “is the user likely to purchase toys for children from ages two-four?” or “is the user likely to have children?” Information about how to map from the interaction to data usable to train the neural network may be obtained from the taxonomy. Continuing the toy store example, to train the neural network to predict the likelihood of a user to purchase toys for children from ages two-four, the taxonomy might indicate that the suitable age range for a toy selected via the interaction should be used in a training pass of the machine learning model.

At 708, the browser or other application persists the neural network weights (or other parameters, as appropriate for the particular machine learning model being employed) in a browser cookie. The browser cookie may be identified so that it can be accessed based at least in part on the taxonomy. For example, the browser cookie might be identified by a domain and by a region in a taxonomy. When an interaction occurs between the browser and a service in the domain, the taxonomy may be used to classify the interaction, and then map from the appropriate region in the taxonomy to the cookie. In at least one instance, a node in the taxonomy corresponds to a type of service interaction, and comprises identifiers of various machine learning models that might be, or have been, trained based on the service interaction. When such an interaction occurs, the browser may search for stored cookies corresponding to the identifiers.

At 710, the cookie is provided with further service interactions. This provision may be subject to various access control restrictions, for example as explained in conjunctions with FIGS. 5 and 6. As just noted, the browser may determine to provide the cookie based on using a taxonomy to classify the interaction and then mapping from a region of the taxonomy to an identifier of a cookie. If a cookie corresponding to the identifier and the service's domain can be found, it can be sent to the service, along with other data pertaining to the interaction.

At 712, the network weights stored in the cookie are used to restore the neural network. This may be performed by a device associated with the service that has received the cookie, such as the web server or application server depicted in FIG. 8. Further explanation of this process is described in conjunction with FIGS. 5 and 6.

In at least one embodiment, the cookie comprises information usable to identify the machine learning model to which the configuration data contained in the cookie pertains. The device which receives the cookie may then proceed to instantiate a machine learning model of that type, and reconstitute it using the configuration data contained in the cookie. For example, the weights of a neural network, as indicated by the configuration data contained in the cookie, might be used to reconstitute the neural network.

At 714, the restored neural network is used, by the device or system that received the cookie, to make predictions. These may be predictions directly related to the questions and observations used to train the network, or other questions with some relation to those original questions. The extent of the capabilities may depend on the type of machine learning model used, the type of data used to train the network, and so forth.

The techniques described in relation to the figures may be further understood in view of an example embodiment of a system. In the example embodiment, the system comprises at least one processor and a memory comprising executable instructions that, in response to execution by the at least one processor, cause the system to obtains data indicative interactions with a service, performed on behalf of an entity. Based on these interactions, the example system trains a machine learning model to make predictions associated with the entity, and stores the parameters of the trained machine learning model. In response to a request to perform an interaction with a second service (which may be the same as the first service) on behalf of the entity, the system provides the parameters to the service with which this interaction will take place. Using these parameters, the service reconstructs the machine learning model, and uses the model to make one or more predictions. The results of the interaction are adjusted based at least in part on these predictions.

In a further embodiment of the example system, the memory comprises further executable instructions that, in response to execution by the at least one processor, cause the system to determine that the first service is associated with a domain, and provide the parameters to the second service when it determines that the second service is also associated with the same domain.

In a further embodiment of the example system, the memory comprises further executable instructions that, in response to execution by the at least one processor, cause the system to obtain a first classification of the first one or more interactions. The system selects the machine learning model for training, from a plurality of machine learning models, based at least in part on the first classification. The system then determines that a subsequent interaction with the second service is in the same classification, or a related classification, and determines to provide the parameters to the second service based on the correspondence between the classifications. The classifications may be based on a taxonomy of interactions, and the taxonomies may further comprise information indicative of various machine learning models and their respective capabilities.

The techniques described in relation to the figures may be further understood in view of an example embodiment of a computer-implemented method. In the example embodiment, a computer-implemented method comprises obtaining data indicative of a first interaction with a first service, performed on behalf of an entity. The method further comprises training a machine learning model, based at least in part on the first interaction, to make predictions associated with the entity. The method further comprises causing the parameters of the trained machine learning model to be stored, and subsequently causing the parameters to be retrieved from storage and provided to a second service, as part of a second interaction with the second service, such that the service can reconstruct the machine learning model and use the machine learning model to make a prediction. The results of this interaction are based, at least in part, on the prediction made with the reconstructed model.

In a further embodiment of the example computer-implement method, the method comprises determining that the first service is associated with a domain, and providing the parameters to the second service based at least in part on determining that the second service is associated with the same domain. Here, domain may refer to internet domains, internet protocol (“IP”) addresses, IP address prefixes, and so on.

In a further embodiment of the example computer-implement method, the method comprises selecting the machine learning model for training based at least in part on a first classification of the first interaction, and determining to provide the parameters to the second service, based at least in part on a second classification of the second interaction. For example, the first classification may be the same as the second classification, or one classification might be a subset of the other.

In a further embodiment of the example computer-implement method, the classifications of interactions are obtained using a taxonomy. The taxonomy may comprise a plurality of regions, or nodes, in which each region or node is indicative of a classification. A region or node in the taxonomy may comprise information mapping from the classification of an interaction to a machine learning model.

In a further embodiment of the example computer-implement method, the method comprises determining to provide the parameters to the second service, based at least in part on contextual information associated with the first entity. As described in relation to FIGS. 1-3, various access policies and acquisition policies may be applied based on contextual information, such as the respective physical locations of the provider of the data and the recipient. Thus, the example method can include applying an access policy that considers the context in which the information might be exchanged, before providing information related to that entity to another party. In a further embodiment, the contextual information is to select a machine learning model with particular relevance to the context in which the model would be provided.

In a further embodiment of the example computer-implement method, the parameters are stored in a browser cookie. As described above in relation to FIG. 7, the parameters may be stored in a browser cookie identified based on the domain to which the cookie applies and an identifier of the machine learning model to which the data stored within the cookie applies. Alternatively, the cookie may be identified based on the domain and a taxonomic classification of an interaction to which the corresponding machine learning model applies.

The techniques described in relation to the figures may be further understood in view of an example embodiment of a computer-readable storage medium. In the example, a non-transitory computer-readable storage medium comprises executable instructions that, in response to being executed by one or more processors of a computing device, cause the computing device to obtain data indicative of a first one or more interactions with a first service, where the first one or more interactions are performed on behalf of a first entity. Execution of the instructions further causes the computing device to train a machine learning model to make predictions associated with the first entity, and cause parameters of the trained machine learning model to be stored. The computing device, in response to execution of the instructions, causes the parameters to be retrieved from storage and provided to a second service, where the second service reconstructs the machine learning model using the parameters, and uses the model to make predictions. The results of interactions with the second service are based at least partly on those predictions.

In a further embodiment of the example computer-readable storage medium, the medium has stored thereon further executable instructions that, in response to being executed by one or more processors, cause the computing device to determine that the first and second services are associated with related domains.

In a further embodiment of the example computer-readable storage medium, the medium has stored thereon further executable instructions that, in response to being executed by one or more processors, cause the computing device to select the machine learning model for training based on a first classification of the first interaction. Execution of the instructions further causes the computing device to provide the parameters of the machine learning model to the second service, based at least in part on a second classification of the second interaction.

In a further embodiment of the example computer-readable storage medium, the first and second classifications are based on a taxonomy. The taxonomy divides potential interactions by semantic meaning, or by some other classification, and associates regions of the taxonomy with machine learning models. The taxonomy may further comprise information indicative of the capabilities of the machine learning model, such as the questions the model is capable of being trained on or the questions the model is capable of answering. The taxonomy may further comprise information indicative of mappings between elements of the interaction (such as parameters to an invocation of a service) and aspects of the machine learning model, such as inputs to the model.

FIG. 8 illustrates aspects of an example environment 800 for implementing aspects in accordance with various embodiments. As will be appreciated, although a web-based environment is used for purposes of explanation, different environments may be used, as appropriate, to implement various embodiments. The environment includes an electronic client device 802, which can include any appropriate device operable to send and/or receive requests, messages, or information over an appropriate network 804 and convey information back to a user of the device. Examples of such client devices include personal computers, cell phones, handheld messaging devices, laptop computers, tablet computers, set-top boxes, personal data assistants, embedded computer systems, electronic book readers, and the like.

The environment 800 in one embodiment is a distributed and/or virtual computing environment utilizing several computer systems and components that are interconnected via communication links, using one or more computer networks or direct connections. However, it will be appreciated by those of ordinary skill in the art that such a system could operate equally well in a system having fewer or a greater number of components than those illustrated in FIG. 8. Thus, the depiction in FIG. 8 should be taken as being illustrative in nature and not limiting to the scope of the disclosure.

The network 804 can include any appropriate network, including an intranet, the Internet, a cellular network, a local area network, a satellite network or any other network, and/or combination thereof. Components used for such a system can depend at least in part upon the type of network and/or environment selected. Many protocols and components for communicating via such network 804 are well known and will not be discussed in detail. Communication over the network 804 can be enabled by wired or wireless connections and combinations thereof. In an embodiment, the network 804 includes the Internet and/or other publicly addressable communications network, as the environment 800 includes one or more web servers 806 for receiving requests and serving content in response thereto, although for other networks an alternative device serving a similar purpose could be used as would be apparent to one of ordinary skill in the art.

The illustrative environment 800 includes one or more application servers 808 and data storage 810. It should be understood that there can be several application servers, layers or other elements, processes or components, which may be chained or otherwise configured, which can interact to perform tasks such as obtaining data from an appropriate data store. Servers, as used, may be implemented in various ways, such as hardware devices or virtual computer systems. In some contexts, “servers” may refer to a programming module being executed on a computer system. As used, unless otherwise stated or clear from context, the term “data store” or “data storage” refers to any device or combination of devices capable of storing, accessing, and retrieving data, which may include any combination and number of data servers, databases, data storage devices, and data storage media, in any standard, distributed, virtual, or clustered environment.

The one or more application servers 808 can include any appropriate hardware, software and firmware for integrating with the data storage 810 as needed to execute aspects of one or more applications for the electronic client device 802, handling some or all of the data access and business logic for an application. The one or more application servers 808 may provide access control services in cooperation with the data storage 810 and is able to generate content including, text, graphics, audio, video, and/or other content usable to be provided to the user, which may be served to the user by the one or more web servers 806 in the form of HyperText Markup Language (HTML), Extensible Markup Language (XML), JavaScript, Cascading Style Sheets (CS S), JavaScript Object Notation (JSON), and/or another appropriate client-side structured language. Content transferred to the electronic client device 802 may be processed by the electronic client device 802 to provide the content in one or more forms including forms that are perceptible to the user audibly, visually, and/or through other senses. The handling of all requests and responses, as well as the delivery of content between the electronic client device 802 and the one or more application servers 808, can be handled by the one or more web servers 806 using PHP: Hypertext Preprocessor (PHP), Python, Ruby, Perl, Java, HTML, XML, JSON, and/or another appropriate server-side structured language in this example. Further, operations described as being performed by a single device may, unless otherwise clear from context, be performed collectively by multiple devices, which may form a distributed and/or virtual system.

Each server typically will include an operating system that provides executable program instructions for the general administration and operation of that server and typically will include a computer-readable storage medium (e.g., a hard disk, random access memory, read only memory, etc.) storing instructions that, when executed (i.e., as a result of being executed) by a processor of the server, allow the server to perform its intended functions.

The data storage 810 can include several separate data tables, databases, data documents, dynamic data storage schemes, and/or other data storage mechanisms and media for storing data relating to a particular aspect of the present disclosure. For example, the data storage 810 may include mechanisms for storing various types of data and user information 816, which can be used to serve content to the electronic client device 802. The data storage 810 also is shown to include a mechanism for storing log data, such as application logs, system logs, access logs, and/or various other event logs, which can be used for reporting, analysis, or other purposes. It should be understood that there can be many other aspects that may need to be stored in the data storage 810, such as page image information and access rights information, which can be stored in any of the above listed mechanisms as appropriate or in additional mechanisms in the data storage 810. The data storage 810 is operable, through logic associated therewith, to receive instructions from the one or more application servers 808 and obtain, update, or otherwise process data in response thereto. The one or more application servers 808 may provide static, dynamic, or a combination of static and dynamic data in response to the received instructions. Dynamic data, such as data used in web logs (blogs), shopping applications, news services, and other applications may be generated by server-side structured languages as described or may be provided by a content management system (CMS) operating on, or under the control of, the one or more application servers 808.

In one embodiment, a user, through a device operated by the user, can submit a search request for a match to a particular search term. In this embodiment, the data storage 810 might access the user information to verify the identity of the user and obtain information about items of that type. The information then can be returned to the user, such as in a results listing on a web page that the user is able to view via a browser on the electronic client device 802. Information related to the particular search term can be viewed in a dedicated page or window of the browser. It should be noted, however, that embodiments of the present disclosure are not necessarily limited to the context of web pages, but may be more generally applicable to processing requests in general, where the requests are not necessarily requests for content.

The various embodiments further can be implemented in a wide variety of operating environments, which in some embodiments can include one or more user computers, computing devices, or processing devices that can be used to operate any of a number of applications. User or client devices can include any of a number of computers, such as desktop, laptop, or tablet computers running a standard operating system, as well as cellular, wireless, and handheld devices running mobile software and capable of supporting a number of networking and messaging protocols. Such a system also can include a number of workstations running any of a variety of commercially available operating systems and other known applications for purposes such as development and database management. These devices also can include other electronic devices, such as dummy terminals, thin-clients, gaming systems, and other devices capable of communicating via the network 804. These devices also can include virtual devices such as virtual machines, hypervisors, and other virtual devices capable of communicating via the network 804.

Various embodiments of the present disclosure utilize the network 804 that would be familiar to those skilled in the art for supporting communications using any of a variety of commercially available protocols, such as Transmission Control Protocol/Internet Protocol (TCP/IP), User Datagram Protocol (UDP), protocols operating in various layers of the Open System Interconnection (OSI) model, File Transfer Protocol (FTP), Universal Plug and Play (UpnP), Network File System (NFS), and Common Internet File System (CIFS). The network 804 can be, for example, a local area network, a wide-area network, a virtual private network, the Internet, an intranet, an extranet, a public switched telephone network, an infrared network, a wireless network, a satellite network, and any combination thereof. In some embodiments, connection-oriented protocols may be used to communicate between network endpoints. Connection-oriented protocols (sometimes called connection-based protocols) are capable of transmitting data in an ordered stream. Connection-oriented protocols can be reliable or unreliable. For example, the TCP protocol is a reliable connection-oriented protocol. Asynchronous Transfer Mode (ATM) and Frame Relay are unreliable connection-oriented protocols. Connection-oriented protocols are in contrast to packet-oriented protocols such as UDP that transmit packets without a guaranteed ordering.

In embodiments utilizing the one or more web servers 806, the one or more web servers 806 can run any of a variety of server or mid-tier applications, including Hypertext Transfer Protocol (HTTP) servers, FTP servers, Common Gateway Interface (CGI) servers, data servers, Java servers, Apache servers, and business application servers. The server(s) also may be capable of executing programs or scripts in response to requests from user devices, such as by executing one or more web applications that may be implemented as one or more scripts or programs written in any programming language, such as Java®, C, C# or C++, or any scripting language, such as Ruby, PHP, Perl, Python, or TCL, as well as combinations thereof. The server(s) may also include database servers, including those commercially available from Oracle Microsoft Sybase®, and IBM® as well as open-source servers such as MySQL, Postgres, SQLite, MongoDB, and any other server capable of storing, retrieving, and accessing structured or unstructured data. Database servers may include table-based servers, document-based servers, unstructured servers, relational servers, non-relational servers, or combinations of these and/or other database servers.

The environment 800 can include a variety of data stores and other memory and storage media as discussed above. These can reside in a variety of locations, such as on a storage medium local to (and/or resident in) one or more of the computers or remote from any or all of the computers across the network 804. In a particular set of embodiments, the information may reside in a storage-area network (SAN) familiar to those skilled in the art. Similarly, any necessary files for performing the functions attributed to the computers, servers or other network devices may be stored locally and/or remotely, as appropriate. Where a system includes computerized devices, each such device can include hardware elements that may be electrically coupled via a bus, the elements including, for example, a central processing unit (CPU or processor), an input device (e.g., a mouse, keyboard, controller, touch screen, or keypad), and an output device (e.g., a display device, printer, or speaker). Such a system may also include one or more storage devices, such as disk drives, optical storage devices, and solid-state storage devices such as random access memory (RAM) or read-only memory (ROM), as well as removable media devices, memory cards, flash cards, etc.

Such devices also can include a computer-readable storage media reader, a communications device (e.g., a modem, a network card (wireless or wired), an infrared communication device, etc.), and working memory as described above. The computer-readable storage media reader can be connected with, or configured to receive, a computer-readable storage medium, representing remote, local, fixed, and/or removable storage devices as well as storage media for temporarily and/or more permanently containing, storing, transmitting, and retrieving computer-readable information. The system and various devices also typically will include a number of software applications, modules, services, or other elements located within a working memory device, including an operating system and application programs, such as a client application or web browser. In addition, customized hardware might also be used and/or particular elements might be implemented in hardware, software (including portable software, such as applets), or both. Further, connection to other computing devices such as network input/output devices may be employed.

Storage media and computer readable media for containing code, or portions of code, can include any appropriate media known or used in the art, including storage media and communication media, such as, volatile and non-volatile, removable and non-removable media implemented in any method or technology for storage and/or transmission of information such as computer readable instructions, data structures, program modules, or other data, including RAM, ROM, Electrically Erasable Programmable Read-Only Memory (EEPROM), flash memory or other memory technology, Compact Disc Read-Only Memory (CD-ROM), digital versatile disk (DVD), or other optical storage, magnetic cassettes, magnetic tape, magnetic disk storage, or other magnetic storage devices, or any other medium which can be used to store the desired information and which can be accessed by the system device. Based on the disclosure and teachings provided, a person of ordinary skill in the art will appreciate other ways and/or methods to implement the various embodiments.

The specification and drawings are, accordingly, to be regarded in an illustrative rather than a restrictive sense. However, it will be evident that various modifications and changes may be made thereunto without departing from the broader spirit and scope of the invention as set forth in the claims. Other variations are within the spirit of the present disclosure. Thus, while the disclosed techniques are susceptible to various modifications and alternative constructions, certain illustrated embodiments thereof are shown in the drawings and have been described above in detail. It should be understood, however, that there is no intention to limit the invention to the specific form or forms disclosed, but on the contrary, the intention is to cover all modifications, alternative constructions, and equivalents falling within the spirit and scope of the invention, as defined in the appended claims.

The use of the terms “a,” “an,” “the,” and similar referents in the context of describing the disclosed embodiments (especially in the context of the following claims) are to be construed to cover both the singular and the plural, unless otherwise indicated or clearly contradicted by context. The terms “comprising,” “having,” “including,” and “containing” are to be construed as open-ended terms (i.e., meaning “including, but not limited to,”) unless otherwise noted. The term “connected,” where unmodified and referring to physical connections, is to be construed as partly or wholly contained within, attached to, or joined together, even if there is something intervening. Recitation of ranges of values are merely intended to serve as a shorthand method of referring individually to each separate value falling within the range, unless otherwise indicated and each separate value is incorporated into the specification as if it were individually recited. The use of the term “set” (e.g., “a set of items”) or “subset” unless otherwise noted or contradicted by context, is to be construed as a nonempty collection comprising one or more members. Further, unless otherwise noted or contradicted by context, the term “subset” of a corresponding set does not necessarily denote a proper subset of the corresponding set, but the subset and the corresponding set may be equal.

Conjunctive language, such as phrases of the form “at least one of A, B, and C,” or “at least one of A, B and C,” is understood with the context as used in general to present that an item, term, etc., may be either A or B or C, or any nonempty subset of the set of A and B and C, unless specifically stated otherwise or otherwise clearly contradicted by context. For instance, in the illustrative example of a set having three members, the conjunctive phrases “at least one of A, B, and C” and “at least one of A, B and C” refer to any of the following sets: {A}, {B}, {C}, {A, B}, {A, C}, {B, C}, {A, B, C}. Thus, such conjunctive language is not generally intended to imply that certain embodiments require at least one of A, at least one of B and at least one of C each to be present. In addition, unless otherwise noted or contradicted by context, the term “plurality” indicates a state of being plural (e.g., “a plurality of items” indicates multiple items). The number of items in a plurality is at least two, but can be more when so indicated either explicitly or by context.

Operations of processes described can be performed in any suitable order unless otherwise indicated or otherwise clearly contradicted by context. Processes described (or variations and/or combinations thereof) may be performed under the control of one or more computer systems configured with executable instructions and may be implemented as code (e.g., executable instructions, one or more computer programs or one or more applications) executing collectively on one or more processors, by hardware or combinations thereof. The code may be stored on a computer-readable storage medium, for example, in the form of a computer program comprising instructions executable by one or more processors. The computer-readable storage medium may be non-transitory. In some embodiments, the code is stored on a set of one or more non-transitory computer-readable storage media having stored thereon executable instructions that, when executed (i.e., as a result of being executed) by one or more processors of a computer system, cause the computer system to perform operations described herein. The set of non-transitory computer-readable storage media may comprise multiple non-transitory computer-readable storage media and one or more of individual non-transitory storage media of the multiple non-transitory computer-readable storage media may lack all of the code while the multiple non-transitory computer-readable storage media collectively store all of the code. Further, in some embodiments, the executable instructions are executed such that different instructions are executed by different processors. As an illustrative example, a non-transitory computer-readable storage medium may store instructions. A main CPU may execute some of the instructions and a graphics processor unit may execute other of the instructions. Generally, different components of a computer system may have separate processors and different processors may execute different subsets of the instructions.

Accordingly, in some embodiments, computer systems are configured to implement one or more services that singly or collectively perform operations of processes described herein. Such computer systems may, for instance, be configured with applicable hardware and/or software that enable the performance of the operations. Further, computer systems that implement various embodiments of the present disclosure may, in some embodiments, be single devices and, in other embodiments, be distributed computer systems comprising multiple devices that operate differently such that the distributed computer system performs the operations described and such that a single device may not perform all operations.

The use of any examples, or exemplary language (e.g., “such as”) provided, is intended merely to better illuminate embodiments of the invention and does not pose a limitation on the scope of the invention unless otherwise claimed. No language in the specification should be construed as indicating any non-claimed element as essential to the practice of the invention.

Embodiments of this disclosure are described, including the best mode known to the inventors for carrying out the invention. Variations of those embodiments may become apparent to those of ordinary skill in the art upon reading the foregoing description. The inventors expect skilled artisans to employ such variations as appropriate and the inventors intend for embodiments of the present disclosure to be practiced otherwise than as specifically described. Accordingly, the scope of the present disclosure includes all modifications and equivalents of the subject matter recited in the claims appended hereto as permitted by applicable law. Moreover, although above-described elements may be described in the context of certain embodiments of the specification, unless stated otherwise or otherwise clear from context, these elements are not mutually exclusive to only those embodiments in which they are described; any combination of the above-described elements in all possible variations thereof is encompassed by the scope of the present disclosure unless otherwise indicated or otherwise clearly contradicted by context.

All references, including publications, patent applications, and patents, cited are hereby incorporated by reference to the same extent as if each reference were individually and specifically indicated to be incorporated by reference and were set forth in its entirety.

What is claimed is:

1. A system, comprising:
at least one processor; and
a memory comprising executable instructions that, in response to execution by the at least one processor, cause the system to:
obtain data indicative of an interaction with a first service, the first interaction performed on behalf of a first entity;
train, based on the data indicative of the first interaction, a machine learning model to make predictions associated with the first entity;
store parameters of the trained machine learning model; and
in response to a request to perform, on behalf of the first entity, a second interaction with a second service, provide the parameters to the second service, wherein the second service reconstructs the machine learning model based at least in part on the parameters, wherein results of the second interaction is based at least in part on a prediction made using the reconstructed machine learning model.

2. The system of claim 1, the memory comprising further executable instructions that, in response to execution by the at least one processor, cause the system to at least:
determine that the first service is associated with a domain; and
provide the parameters to the second service based at least in part on determining that the second service is also associated with the domain.

3. The system of claim 1, the memory comprising further executable instructions that, in response to execution by the at least one processor, cause the system to at least:
obtain a first classification of the first interaction;
select the machine learning model for training, wherein the machine learning model is selected, from a plurality of machine learning models, based at least in part on the first classification;
obtain a second classification of the second interaction; and
determine to provide the parameters to the second service, based at least in part on a relationship between the second classification and the first classification.

4. The system of claim 3, wherein the first classification is obtained based at least in part on a taxonomy of interactions.

5. The system of claim 4, wherein the taxonomy comprises information indicative of a relationship between the first classification and the machine learning model.

6. A computer-implemented method, comprising:
obtaining data indicative of a first interaction with a first service, the first interaction associated with a first entity;
training a machine learning model, based on the data indicative of the first interaction, to make a prediction associated with the first entity;
causing parameters of the trained machine learning model to be stored; and
causing the parameters to be provided with a second interaction with a second service, wherein the second service reconstructs the machine learning model based at least in part on the parameters, wherein a result of the second interaction is based at least in part on a prediction made using the reconstructed machine learning model.

7. The method of claim 6, further comprising:
determining that the first service is associated with a domain; and
providing the parameters to the second service based at least in part on determining that the second service is also associated with the domain.

8. The method of claim 6, further comprising:
selecting the machine learning model for training based at least in part on a first classification of the first interaction; and
determining to provide the parameters to the second service, based at least in part on determining that a second classification of the second interaction is related to the first classification.

9. The method of claim 8, wherein the first classification is determined based at least in part on a taxonomy.

10. The method of claim 9, wherein the taxonomy comprises information mapping from the first and second classifications to the machine learning model.

11. The method of claim 6, further comprising:
determining to provide the parameters to the second service, based at least in part on contextual information associated with the first entity.

12. The method of claim 6, wherein the machine learning model is a neural network.

13. The method of claim 6, wherein the parameters are stored in a browser cookie whose identifier is based at least in part on the machine learning model.

14. The method of claim 6, wherein provision of the parameters is controlled by an access policy defined by the first entity.

15. A non-transitory computer-readable storage medium having stored thereon executable instructions that, in response to being executed by one or more processors of a computing device, cause the computing device to at least:
obtain data indicative of a first one or more interactions with a first service, the first one or more interactions performed on behalf of a first entity;
train a machine learning model to make predictions associated with the first entity;
cause parameters of the trained machine learning model to be stored; and
cause the parameters to be provided to a second service, wherein the second service reconstructs the machine learning model based at least in part on the parameters, wherein results of a second one or more interactions with the second service are based at least in part on a prediction made using the reconstructed machine learning model.

16. The non-transitory computer-readable storage medium of claim 15, having stored thereon further executable instructions that, in response to being executed by one or more processors, cause the computing device to at least:
determine that the first service and second service are associated with related domains.

17. The non-transitory computer-readable storage medium of claim 15, having stored thereon further executable instructions that, in response to being executed by one or more processors, cause the computing device to at least:
select the machine learning model for training based at least in part on a first classification of the first one or more interactions; and
provide the parameters to the second service, based at least in part on determining that a second classification of the second one or more interactions corresponds to the first classification.

18. The non-transitory computer-readable storage medium of claim 17, wherein an element of a taxonomy maps from the first classification to the machine learning model.

19. The non-transitory computer-readable storage medium of claim 15, wherein the parameters are provided to the second service based at least in part on determining that the second one or more interactions are being performed on behalf of the first entity.

20. The non-transitory computer-readable storage medium of claim 15, wherein the machine learning model is an artificial neural network.
